(19) United States
(12) Patent Application Publication
(10) Pub. No.: US 2006/0294598 A1
(43) Pub. Date: Dec. 28, 2006

(54) Community instance access control in a collaborative system

(75) Inventors: Derek S. Lam, Arlington, MA (US); Joseph A. Russo, Westford, MA (US); Sami M. Shalabi, Winchester, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/167,534

(22) Filed: Jun. 27, 2005

(51) Int. Cl. H04L 9/32; H04N 7/16; H04L 9/00; G06F 17/30; G06F 7/04; G06K 9/00; H03M 1/68; H04K 1/00

(52) U.S. Cl. 726/28; 726/29; 713/166; 713/167

(57) ABSTRACT

Embodiments of the present invention address deficiencies of the art in respect to access control in a collaborative environment and provide a method, system and computer program product for community instance access control in a collaborative environment. In one embodiment, a data processing system for community instance access control in a collaborative environment can include a collaborative environment including one or more resources for use by one or more users registered in the collaborative environment. The data processing system further can include one or more community instances, each of the community instances including a one or more roles, each of the community instances further including one or more of the users assigned to respective ones of the roles. Finally, the data processing system can include access control logic managing access to the resources by the users in the community instances based upon softgroups provided by the community instances to the access control logic.

### BACKGROUND OF THE INVENTION

1. Field of the Invention

The present invention relates to the field of collaborative computing and more particularly to the field of access control in a collaborative system.

2. Description of the Related Art

The rapid development of the Internet has led to advanced modes of communication and collaboration. Using the Internet as a backbone, individuals worldwide can converge in cyberspace to share ideas, documents and images in a manner not previously possible through conventional telephony and video conferencing. To facilitate collaboration over the Internet, a substantial collection of technologies and protocols have been assembled to effectively deliver audio, video and data over the single data communications medium of the Internet. These technologies include document libraries, instant messaging, chat rooms, and application sharing.

Conventional collaborative computing includes combinations of collaborative technologies in order to provide a means for members of a collaborative community to pool their strengths and experiences to achieve a common goal. For instance, a common goal can include an educational objective, the completion of a software development project or even the creation and use of a system to manage human resources. A collaborative computing community generally can be defined by (1) a particular context, i.e. the objective of the environment, (2) membership, i.e., the participants in the environment, (3) a set of roles for the members, and (4) resources and tools which can be accessed by the membership in furtherance of the objective of the environment. Roles are names given to the people in the environment which dictate access to the resources and tools within the environment as well as define the behavior of the community members.

Collaborative communities can be multi-hierarchical. That is different members of a community can fulfill multiple roles at different tiers of a hierarchy. Thus, in a collaborative community, members can be structured differently within the same community depending upon a particular role. For instance, in an educational community, members of the community can be hierarchically classified according teacher and student, as well as by social security number, as well as by gender, as well as by extracurricular affiliation. Notably, in some communities, different members can fulfill multiple roles, including student-teachers, player-coaches, and owner-operators.

Access control within a collaborative community refers to the moderation of access to a selected resource based upon either the identity of a community member, or a role fulfilled by the community member. For instance, community members fulfilling a moderator's role in a conference can enjoy both write and read access to an agenda for the conference, whereas community members fulfilling a mere attendee's role in a conference can enjoy only read access. Managing access control for each accessible resource in a collaborative computing environment can be challenging as every user and group of users requiring access to a resource must be managed. Where a large number of resources and users are to be managed in a community, the task of access control can be overwhelming.

To facilitate the process of access control in a collaborative environment, role based access is provided. In this regard, access to resources in the collaborative environment can be moderated based upon a role for a collaborator rather than the identity of a specific collaborator. As such, so long as a user is assigned to a particular role managed according to access control attributes assigned to the role, the user will be permitted access to those resources to which access has been permitted for the role. Despite the apparent flexibility afforded to the process of access control by the role mechanism, it is to be understood that oftentimes, collaborators can fulfill multiple different roles which warrant different access rights to resources depending upon the role fulfilled in a community. Accordingly, the role mechanism cannot provide the granular level of access control required in a community.

### BRIEF SUMMARY OF THE INVENTION

Embodiments of the present invention address deficiencies of the art in respect to access control in a collaborative environment and provide a novel and non-obvious method, system and computer program product for community instance access control in a collaborative environment. In one embodiment, a data processing system for community instance access control in a collaborative environment can include a collaborative environment including one or more resources for use by one or more users registered in the collaborative environment. The data processing system further can include one or more community instances, each of the community instances including a one or more roles, each of the community instances further including one or more of the users assigned to respective ones of the roles.

Finally, the data processing system can include access control logic managing access to the resources by the users in the community instances based upon “softgroups” provided by the community instances to the access control logic. As used herein, softgroups refer to a specification of roles defined for a community instance in the collaborative environment. In consequence, as users are assigned to particular roles in a community instance, the users will acquire access rights already afforded to role by virtue of the processing of the softgroup in the access control logic. It will be recognized, then, that users can fulfill different roles in different community instances of the same community, and thus can enjoy varying access rights from community instance to community instance depending upon the role assigned to the user in each community.

In another embodiment of the invention, a method for community instance access control in a collaborative environment can include creating an instance of a community based upon a community class. The method further can include producing a softgroup based upon roles defined for the created instance. Finally, the method can include providing the softgroup to access control logic managing access to resources for the created instance. In one aspect of the embodiment, providing the softgroup to access control logic managing access to resources for the created instance can include forwarding the softgroup to the access control logic, and establishing access rights for resources in the collaborative environment for each role in the softgroup. As such, in another aspect of the embodiment, the method further can include receiving a request by a user in the created instance to access a selected resource through the created instance, and limiting access to the selected resource based upon the established access rights for the selected resource for a role assigned to the user by the created instance.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a collaborative environment configured for community instance access control;

FIG. 2 is a schematic illustration of a collaborative environment configured for community instance access control; and,

FIG. 3 is a flow chart illustrating a process for community instance access control in a collaborative environment.

### DETAILED DESCRIPTION OF THE INVENTION

Embodiments of the present invention provide a method, system and computer program product for community instance access control in a collaborative environment. In accordance with an embodiment of the present invention, a community instance can be created for a community class, and particular users in the collaborative environment can be assigned to corresponding roles within the community instance. The roles in the community instance can be provided to access control logic and are referred to herein as “softgroups”. The access control logic in turn can grant levels of access rights to the different roles in the softgroup for the community instance irrespective of the individual access rights of the user members in the softgroup or the external roles assigned to the user members. In this way, users assigned to roles for the community instance can be afforded seamless access to resources utilized from within the community instance without requiring the granular management of access rights for the user in the community instance.

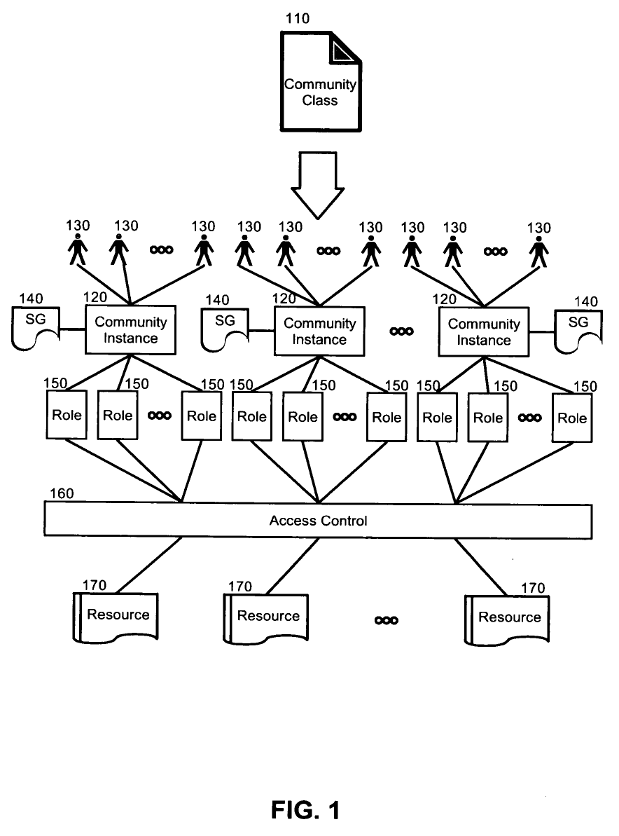

In more particular illustration, FIG. 1 is a pictorial illustration of a collaborative environment configured for community instance access control. The collaborative environment can include a community class 110 from which one or more community instances 120 can be created. The community class 110 can define one or more roles 150 which can be included as part of each community instance 120. To that end, one or more users 130 registering with a particular one of the community instances 120 can be assigned to one of the corresponding roles 150 for purposes of that community instance 120 only.

Each community instance 120 can generate a softgroup 140 which can include a listing of the roles 150 for the community instance 120. The softgroup 140 can be provided to access control logic 160 and each role 150 specified in the softgroup 140 can be assigned particular access rights to particular ones of the resources 170 which can be accessed in the community instance 120. Subsequently, as a user 130 is added to a particular community instance 120, the user 130 can be assigned to a particular role 150 in the particular community instance 120. By default, then, the added user 130 can be afforded access rights to those resources 170 through the particular community instance 120 as permitted by the role 150 assigned to the added user 130. However, no granular assignment of access rights, either for the added user 130 or the external role assigned to the added user 130, are required.

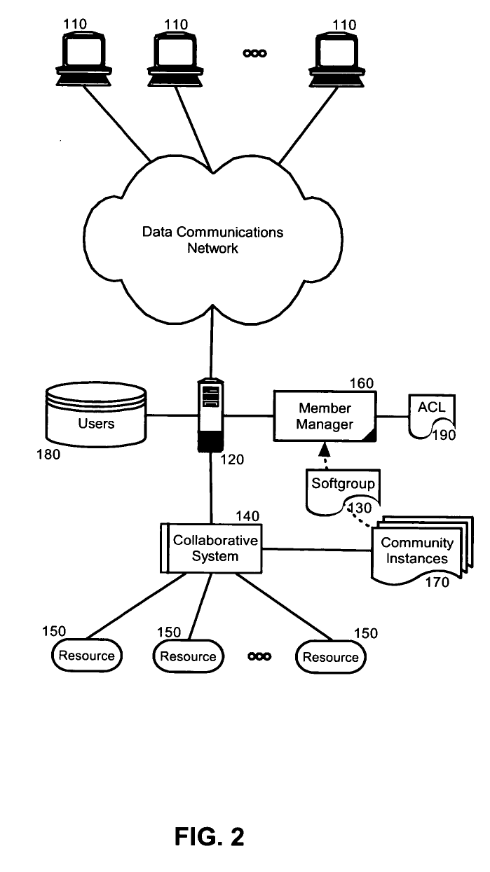

In further illustration, FIG. 2 is a schematic illustration of a collaborative environment configured for community instance access control. The system can include a host computing platform 120 coupled to one or more client computing platforms 110 over a data communications network. The host computing platform 120 can include a collaborative system 140 communicatively coupled to a directory of users 180 and one or more resources 150. The collaborative system 140 can be configured to create different community instances 170 from a community class. Each of the community instances 170 can provide an interface for adding selected ones of the users 180 and for assigning particular roles to the selected ones of the users 180 within the community instance 170.

Each of the community instances 170 can implement an interface for providing a softgroup 130 to a member manager 160. The member manager 160 can control access to the resources 150 by reference to an access control list 190. As part of the control of access to the resources 150, the member manager 160 can assign different access rights to different ones of the resources 150 for different roles within a community instance 170 specified within the softgroup 130. In this way, as users 180 are added to a community instance 170 and assigned respective roles within the community instance, the users 180 can enjoy access to the resources 150 based upon the rights afforded to the respective roles for the community instance 170 defined within the softgroup 130. Accordingly, the granular management of access rights for the individual users 180 can be avoided.

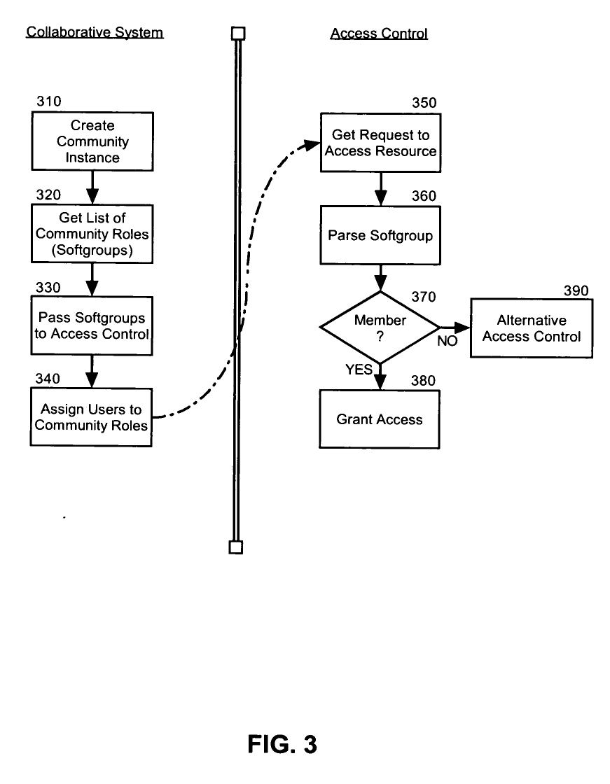

FIG. 3 is a flow chart illustrating a process for community instance access control in a collaborative environment. Beginning in block 310, a community instance can be created from a community class. Once the community instance has been created, in block 320 a list of community roles can be generated for the different roles associated with the community. Subsequently, a softgroup containing the list of community roles can be provided to access control logic in block 330 and different users in the collaborative environment can be assigned to respective ones of the roles in block 340 as the different users are added to the community instance.

In block 350, a request can be received in the access control logic for accessing a resource on behalf of a user in a community instance. In block 360, one or more softgroups for the community instance disposed within the access control list can be parsed to determine whether the role assigned to the requesting user for the community instance has been specified in a softgroup. If so, access can be granted 380 based upon the inclusion of the role in the softgroup. Otherwise, in block 390 alternative access control can be performed. The alternative access control can range from a denial of access to a more conventional determination of whether the requesting user enjoys access permissions to the desired resource irrespective of the community instance.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A data processing system for community instance access control in a collaborative environment comprising:
a collaborative environment comprising a plurality of resources for use by a plurality of users registered in the collaborative environment;
a plurality of community instances, each of said community instances comprising a plurality of roles, each of said community instances further comprising a plurality of said users assigned to respective ones of said roles; and,
access control logic managing access to said resources by said users in said community instances based upon softgroups provided by said community instances to said access control logic.

2. A method for community instance access control in a collaborative environment, the method comprising:
creating an instance of a community based upon a community class;
producing a softgroup based upon roles defined for said created instance; and,
providing said softgroup to access control logic managing access to resources for said created instance.

3. The method of claim 2, wherein said producing a softgroup based upon roles defined for said community instance, comprises populating a list with roles defined for said created instance.

4. The method of claim 2, wherein said providing said softgroup to access control logic managing access to resources for said created instance, comprises:
forwarding said softgroup to said access control logic; and,
establishing access rights for resources in the collaborative environment for each role in said softgroup.

5. The method of claim 4, further comprising:
receiving a request by a user in said created instance to access a selected resource through said created instance; and,
limiting access to said selected resource based upon said established access rights for said selected resource for a role assigned to said user by said created instance.

6. The method of claim 4, wherein said forwarding said softgroup to said access control logic comprises forwarding said softgroup to access control logic disposed in a member manager.

7. A computer program product comprising a computer usable medium having computer usable program code for community instance access control in a collaborative environment, said computer program product including:
computer usable program code for creating an instance of a community based upon a community class;
computer usable program code for producing a softgroup based upon roles defined for said created instance; and,
computer usable program code for providing said softgroup to access control logic managing access to resources for said created instance.

8. The computer program product of claim 7, wherein said computer usable program code for producing a softgroup based upon roles defined for said community instance, comprises computer usable program code for populating a list with roles defined for said created instance.

9. The computer program product of claim 7, wherein said computer usable program code for providing said softgroup to access control logic managing access to resources for said created instance, comprises:
computer usable program code for forwarding said softgroup to said access control logic; and,
computer usable program code for establishing access rights for resources in the collaborative environment for each role in said softgroup.

10. The computer program product of claim 9, further comprising:
computer usable program code for receiving a request by a user in said created instance to access a selected resource through said created instance; and,
computer usable program code for limiting access to said selected resource based upon said established access rights for said selected resource for a role assigned to said user by said created instance.

11. The computer program product of claim 9, wherein said computer usable program code for forwarding said softgroup to said access control logic comprises computer usable program code for forwarding said softgroup to access control logic disposed in a member manager.
